(19) United States
(12) Patent Application Publication
(10) Pub. No.: US 2021/0197282 A1
(43) Pub. Date: Jul. 1, 2021

(54) METHOD AND APPARATUS FOR ESTIMATING HEIGHT OF 3D PRINTING OBJECT FORMED DURING 3D PRINTING PROCESS, AND 3D PRINTING SYSTEM HAVING THE SAME

(71) Applicant: Korea Advanced Institute of Science and Technology, Daejeon (KR)

(72) Inventors: Hoon SOHN, Daejeon (KR); Ikgeun JEON, Daejeon (KR)

(73) Assignee: Korea Advanced Institute of Science and Technology, Daejeon (KR)

(21) Appl. No.: 17/123,535

(22) Filed: Dec. 16, 2020

(30) Foreign Application Priority Data
Dec. 31, 2019 (KR) 10-2019-0179188

(51) Int. Cl. B22F 10/85; B22F 10/25; B22F 12/41; B22F 12/90; G06T 7/60; G06T 7/00; B33Y 50/02

(52) U.S. Cl. CPC B22F 10/85; B22F 10/25; B22F 12/41; B22F 12/90; G06T 7/60; B33Y 10/00; B33Y 50/02; G06T 2207/10048; G06T 2207/20081; G06T 2207/20084; G06T 2207/30164; G06T 7/0004

(57) ABSTRACT

A method and apparatus for estimating a height of a 3D printing object formed during a 3D printing process are disclosed. The method includes extracting one or more temperature-related data of the 3D printing object formed during the 3D printing process, building an artificial neural network model for estimating the height of the 3D printing object by using the extracted temperature-related data; and estimating the height of the 3D printing object by inputting a newly measured thermal image and the one or more temperature-related data values into the artificial neural network model. The height of the 3D printing object can be measured in real time.

### CROSS-REFERENCE TO RELATED APPLICATION

This U.S. non-provisional application claims priority under 35 USC § 119 from Korean Patent Application No. 10-2019-0179188, filed on Dec. 31, 2019 in the Korean Intellectual Property Office (KIPO), the disclosure of which is hereby incorporated by reference in its entirety.

### BACKGROUND

### 1. Technical Field

The present disclosure relates to a 3D printing technology, and more particularly, to a method and apparatus for estimating a height of a three-dimensional (3D) printing object formed during a 3D printing process, and a 3D printing system including the apparatus.

### 2. Description of the Related Art

The 3D printing is known as a manufacturing technology for producing a 3D object. For the 3D printing of the 3D object, it is processed in a way that printing layer by layer based on the 3D model data processing information. The 3D printing technology has advantages that facilitate realization of a complex shape, a shape formed inside a product, etc. Due to these advantages, the 3D printing technology is in the spotlight as a high value-added technology that makes it easy to manufacture various products such as various industrial parts and medical materials.

The 3D printing process can be performed by dividing the shape of a 3D product into a number of 2D cross sections having a uniform or variable thickness, and forming the 2D cross sections to be stacked one by one. There are several known 3D printing methods such as a material extrusion method, a material jetting method, a binder jetting method, a sheet lamination method, a vat photo-polymerization method, a powder bed fusion method, a directed energy deposition (DED) method, etc. Among them, the DED method is a method of applying laser energy to metal powder or wire material to be melted and fused, and is widely used because of its advantages that it can use inexpensive commercial materials compared to other methods, form a lamination on existing 3D shapes, and have superior mechanical properties compared to other methods.

In the 3D printing according to the DED method, a molten pool is formed when a laser beam irradiated from a laser source is irradiated to the substrate, and metal powder is supplied onto the molten pool to form a lamination.

The 3D printing object, that is, the object printed by the 3D printing process may include a portion that is newly laminated on the already printed portion as a base material such as metal powder or metal wire is melted by the 3D printing laser. The height of the 3D printing object may be generally determined by the amount of base material for the 3D printing, the intensity of laser generated by the 3D printer, the printing speed, etc. but the height may change depending on the temperature and shape of the portion to be printed.

Maintaining a constant height of the printed layer is an important factor in determining the quality and property of the printed layer. However, until now a technology for measuring and maintaining a constant distance between a nozzle of the 3D printer and the 3D printing object has been developed, but there is no technology developed for estimating the height of the printed layer in real time during the 3D printing process.

### SUMMARY

Some embodiments of the present disclosure are to provide a method capable of estimating a height of a 3D printing object formed during a 3D printing process in real time, and an apparatus for the same.

Some embodiments of the present disclosure are to provide a 3D printing system including the apparatus.

In one aspect, some embodiments of the present disclosure provide a method of estimating a height of a 3D printing object formed during a 3D printing process. The method includes extracting one or more temperature-related data of the 3D printing object formed during the 3D printing process; building an artificial neural network model for estimating the height of the 3D printing object by using the extracted temperature-related data; and estimating the height of the 3D printing object by inputting a newly measured thermal image and the one or more temperature-related data into the artificial neural network model. Here, the one or more temperature-related data includes a surface temperature phase and a temperature amplitude change of the 3D printing object.

In an embodiment, the step of ‘extracting one or more temperature-related data of the 3D printing object’ may include capturing a thermal image of the 3D printing object using the thermal imaging camera capable of measuring a temperature of the 3D printing object formed during the 3D printing process; and extracting one or more temperature-related data of the 3D printing object from the thermal image of the 3D printing object taken by the thermal imaging camera.

In an embodiment, the ‘building an artificial neural network model’ may include collecting big data including thermal images, and information on correlations between one or more temperature-related data and the heights of the 3D printing object at various heights of the 3D printing object by repeatedly performing, at various heights of the 3D printing object, the steps of capturing a thermal image of the 3D printing object using the thermal imaging camera, and extracting one or more temperature-related data of the 3D printing object from the thermal image of the 3D printing object; and building the artificial neural network model by machine learning the collected big data.

In an embodiment, the 3D printing process may be a 3D printing process using a direct energy deposition (DED) method.

In an embodiment, a base material of the 3D printing object may be a metal material.

In other aspect, some embodiments of the present disclosure provide an apparatus for estimating a height of a 3D printing object formed during a 3D printing process. The apparatus includes a thermal imaging camera, and a calculation unit. The thermal imaging camera is configured to measure a temperature of the 3D printing object formed during the 3D printing process. The calculation unit is configured to estimate the height of the 3D printing object from the temperature of the 3D printing object unit measured by the thermal imaging camera. The calculation unit includes functions of: extracting one or more temperature-related data of the 3D printing object formed during the 3D printing process; building an artificial neural network model for estimating the height of the 3D printing object by using the extracted temperature-related data; and estimating the height of the 3D printing object by inputting a newly measured thermal image and the one or more temperature-related data values into the artificial neural network model. The one or more temperature-related data includes a surface temperature phase and a temperature amplitude change of the 3D printing object.

In an embodiment, the function of ‘extracting one or more temperature-related data of the 3D printing object’ may include a function of capturing a thermal image of the 3D printing object using the thermal imaging camera capable of measuring a temperature of the 3D printing object formed during the 3D printing process; and a function of extracting one or more temperature-related data of the 3D printing object from the thermal image of the 3D printing object taken by the thermal imaging camera.

In an embodiment, the function of ‘building an artificial neural network model’ comprises a function of collecting big data including thermal images, and information on correlations between one or more temperature-related data and the heights of the 3D printing object at various heights of the 3D printing object by repeatedly performing, at various heights of the 3D printing object, tasks of capturing a thermal image of the 3D printing object using the thermal imaging camera and extracting one or more temperature-related data of the 3D printing object from the thermal image of the 3D printing object; and a function of building the artificial neural network model by machine learning the collected big data.

In further other aspect, some embodiments of the present disclosure provide a system for 3D printing process which includes a laser source, a base material supply source, a thermal imaging camera, and a calculation unit. The laser source is configured to form a molten pool on a 3D printing object by irradiating a laser beam to melt a base material supplied to the 3D printing object. The base material supply source is configured to supply the base material to the 3D printing object. The thermal imaging camera is configured to measure a temperature of the 3D printing object by imaging the 3D printing object formed during the 3D printing process. The calculation unit is configured to estimate the height of the 3D printing object from the temperature of the 3D printing object unit measured by the thermal imaging camera. The calculation unit includes functions of: extracting one or more temperature-related data of the 3D printing object formed during the 3D printing process; building an artificial neural network model for estimating the height of the 3D printing object by using the extracted temperature-related data; and estimating the height of the 3D printing object by inputting a newly measured thermal image and the one or more temperature-related data values into the artificial neural network model. The one or more temperature-related data includes a surface temperature phase and a temperature amplitude change of the 3D printing object.

In an embodiment, the thermal imaging camera may be disposed such that at least a part of an optical path of the thermal imaging camera is coaxially with a laser beam irradiated from the laser source that melts a base material supplied to the 3D printing object.

In an embodiment, the 3D printing system may further include a beam splitter disposed on a beam path irradiated from the laser source; and an optical path converter disposed between the beam splitter and the thermal imaging camera to change a path of light, wherein the thermal imaging camera is disposed coaxially with the laser source.

In an embodiment, the beam splitter may be disposed between the laser source and a focus lens through which laser beam emitted from the laser source passes.

In an embodiment, the calculation unit may be configured to estimate the height of the 3D printing object in real time during the 3D printing process.

In an embodiment, the 3D printing system may further include a display unit configured to display the height of the 3D printing object estimated by the calculation unit.

According to embodiments of the present disclosure, a thermal image of the 3D printing object formed during the 3D printing process can be measured using the thermal imaging camera, and a height of the 3D printing object may be estimated in real time using this.

According to embodiments of the present disclosure, an artificial neural network model can be constructed using big data, which can be obtained by collecting the correlation between the thermal image of the 3D printing object formed during the 3D printing process and one or more temperature-related data and the height of the 3D printing object. And the height of the 3D printing object can be estimated in real time using the artificial neural network model.

According to embodiments of the present disclosure, the height of the 3D printing object can be estimated in real time during the 3D printing process, so that 3D printing quality can be checked in real time.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram of a 3D printing system according to an embodiment of the present disclosure.

FIG. 2 is a flowchart of a method of estimating a height of a 3D printing object by the 3D printing system according to an embodiment of the present disclosure.

FIG. 3 is a schematic diagram in which the 3D printing object is formed by a laser beam irradiated by the 3D printing system according to an embodiment of the present disclosure.

FIG. 4A illustrates a laser beam passing through position A at time tin the 3D printing system, and FIG. 4B illustrates a laser beam passing through position B at time t+Δt.

FIG. 5A is a graph of temperature phase according to the height of the 3D printing object, and FIG. 5B is a graph of temperature amplitude according to the height of the 3D printing object.

FIG. 6 is a schematic diagram of analyzing a correlation between a thermal image and one or more temperature-related data and a height of the 3D printing object using machine learning.

FIG. 7A illustrates 3D printing objects of a 3D printing structure, and FIG. 7B is a view showing the 3D printing objects of the 3D printing structure shown in FIG. 7A which are distinguished in different colors according to the heights thereof.

### DETAILED DESCRIPTION OF THE EMBODIMENTS

Hereinafter, embodiments of the present disclosure will be described in detail with reference to the accompanying drawings. The present disclosure may be implemented in various different forms, and is not limited to the embodiments described herein. In the drawings, parts irrelevant to the description are omitted in order to clearly describe the present disclosure, and the same reference numerals are assigned to the same or similar elements throughout the specification.

The 3D printing system according to an embodiment of the present disclosure is a system capable of melting a base material using a laser to form a three-dimensional object, and also estimating a height of a 3D printing object during the 3D printing process in real time. The 3D printing system according to an embodiment of the present disclosure may be a DED type 3D printing system capable of forming a 3D object by melting metal powder or metal wire with a laser.

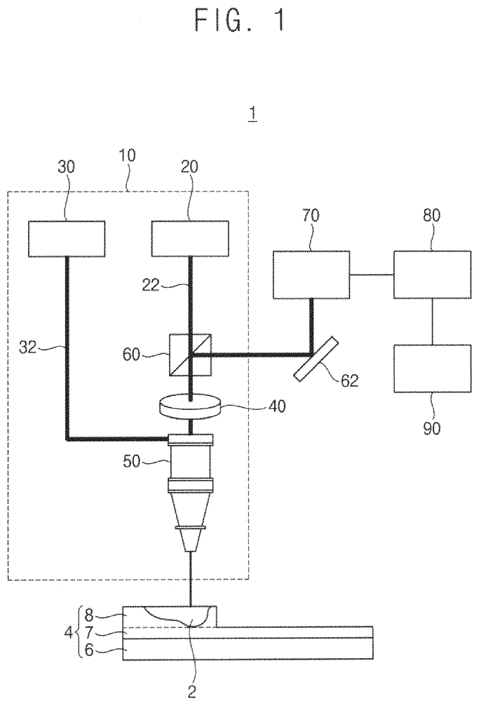

FIG. 1 illustrates a configuration of a 3D printing system according to an embodiment of the present disclosure.

Referring to FIG. 1, in an example embodiment the 3D printing system 1 may include a laser source 20 for 3D printing, a base material supply source 30, a focus lens 40, a nozzle 50, and a thermal imaging camera 70, a calculation unit 80, and a display unit 90.

In an example embodiment, the laser source 20 may irradiate a laser beam 22 to a 3D printing object 4. The laser beam 22 irradiated from the laser source 20 passes through the focus lens 40 and is incident on the 3D printing object 4. The laser beam 22 irradiated from the laser source 20 may pass through the nozzle 50 for supplying the base material while the laser beam 22 reaches a molten pool 2.

In an example embodiment, the base material supplied from the base material supply source 30 may be fed to the nozzle 50 in the form of, for example, metal powder or metal wire through a separate supply pipe 32. To supply the base material to the 3D printing object 4, the movement path of the base material in the nozzle 50 may be formed to be parallel to or oblique to the path through which the laser beam 22 passes. The base material supplied to the 3D printing object 4 may be melted by the laser source 20 to form the molten pool 2 in the 3D printing object 4.

The 3D printing object 4 may be formed as a three-dimensional object by laminating a plurality of layers. In FIG. 1, illustrated is an example state where the 3D printing object 4 is formed of, for example, a first layer 6 and a second layer 7, and a third layer 8, and the molten pool 2 is formed on the third layer 8.

In the 3D printing system 1 according to an embodiment of the present disclosure, the laser source 20, the base material supply source 30 and the supply pipe 32, the focus lens 40 and the nozzle 50 may form a general DED type 3D printer 10. The 3D printer 10 that can be applied to the 3D printing system 1 according to the example embodiment of the present disclosure is not limited to the DED type 3D printer. If any 3D printer can form the molten pool 2 using metal as the base material, it can be applied to the 3D printing system 1.

In the 3D printing system 1, a thermal imaging camera 70 may be provided to extract one or more temperature-related data related to the 3D printing object 4 in order to estimate the height of the 3D printing object 4. The factor measured by the thermal imaging camera 70 may be a temperature distribution of the 3D printing object 4, for example, the surface temperature of the molten pool 2 and its surroundings.

In order to extract one or more temperature-related data which is related the 3D printing object 4 with the thermal imaging camera 70, a beam splitter 60 may be installed between the laser source 20 and the focusing lens 40.

The beam splitter 60 may be disposed on a path through which the laser beam 22 irradiated from the laser source 20 travels to the molten pool 2 and change the path of light reflected from the molten pool 2. The light changed by the beam splitter 60 may pass through an optical path converter 62 and be photographed by the thermal imaging camera 70. The optical path converter 62 that converts the optical path may be, for example, a reflecting mirror. Accordingly, the thermal imaging camera 70 can measure the surface temperature of the molten pool 2.

In an example embodiment, the thermal imaging camera 70 may be disposed coaxially with the nozzle 50 for irradiating laser light. Since the thermal imaging camera 70 is installed coaxially with the nozzle 50 of the 3D printer, it is possible to continuously photograph the 3D printing object 4 without controlling the position of the thermal imaging camera 70.

In an example embodiment, the thermal imaging camera 70 may be installed in the 3D printer together with the optical path converter 62 and the beam splitter 60 to measure the surface temperature of the molten pool 2 of the 3D printer.

In the 3D printing system 1 according to an example embodiment, the calculation unit 80 may be provided to estimate the height of the 3D printing object 4 by using the surface temperature of the molten pool 2 on the 3D printing object 4 and the peripheral region of the molten pool 2 measured by the thermal imaging camera 70.

Hereinafter, a method of estimating the height of the 3D printing object 4 using the calculation unit 80 of the 3D printing system 1 will be described with reference to different drawings.

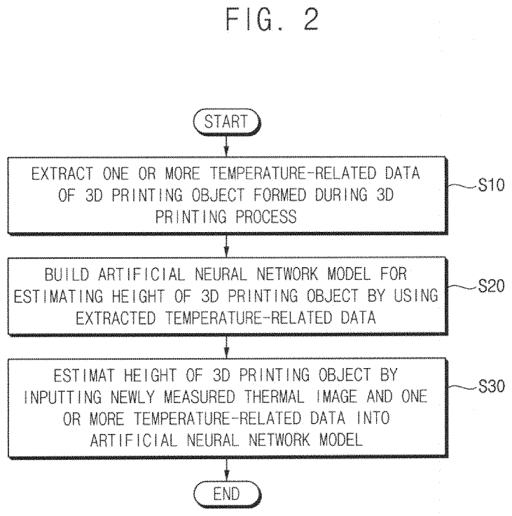

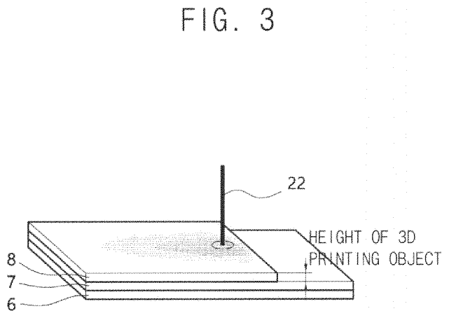

FIG. 2 shows a procedure of a method of estimating a height of a 3D printing object by the 3D printing system according to an embodiment of the present disclosure. FIG. 3 illustrates that a 3D printing object is formed by a laser beam irradiated by the 3D printing system.

Referring to FIGS. 2 and 3, a method of estimating a height of a 3D printing object 4 formed during a 3D printing process according to an example embodiment may include a step of extracting one or more temperature-related data of the 3D printing object 4 formed during a 3D printing process (S10), and a step of building an artificial neural network model for estimating a height of the 3D printing object 4 by using the extracted temperature-related data (S20), and a step of estimating the height of the 3D printing object 4 by inputting a newly measured thermal image and the one or more temperature-related data into the artificial neural network model (S30).

In step S10 of extracting the one or more temperature-related data, the thermal imaging camera 70 may be provided to measure the temperature of the layered portion formed during the 3D printing process. In an example embodiment, the thermal imaging camera 70 may be provided integrally with the 3D printer system 1 to be disposed coaxially with the nozzle 50 as described above. In another example embodiment, a separate thermal imaging camera may be provided to be combined with an existing 3D printer.

In the example embodiment, after the thermal imaging camera 70 is provided as described above, an image of the temperature distribution of the 3D printing object 4 may be taken with the thermal imaging camera 70. In this case, the image of the temperature distribution of the 3D printing object 4 may include the molten pool 2 of the 3D printing object 4 and the surrounding region of the molten pool 2.

After that, one or more temperature-related data may be extracted from the temperature distribution image of the 3D printing object 4. In an embodiment, the temperature-related data may include surface temperature phase data and temperature amplitude change data.

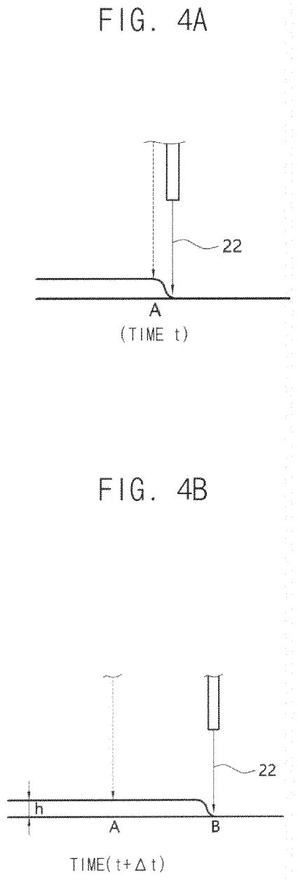

FIG. 4A illustrates a laser beam passing through position A at time t in the 3D printing system, and FIG. 4B is a diagram illustrating a laser beam passing through point B at time t+Δt.

With reference to FIGS. 4A and 4B, let a position at which the height of the 3D printing object 4 is to be measured is position A in the 3D printing process according to an embodiment of the present disclosure. The laser beam may pass through position A at time t and a molten pool may be formed at position A as being melted to a certain temperature T1. At this time, the temperature at position A may be measured by the thermal imaging camera 70.

Thereafter, while time Δt elapses, the laser beam may be moved to pass through position B. In the process, the molten pool formed at position A may be hardened into a 3D printing object having a predetermined height as the temperature decreases.

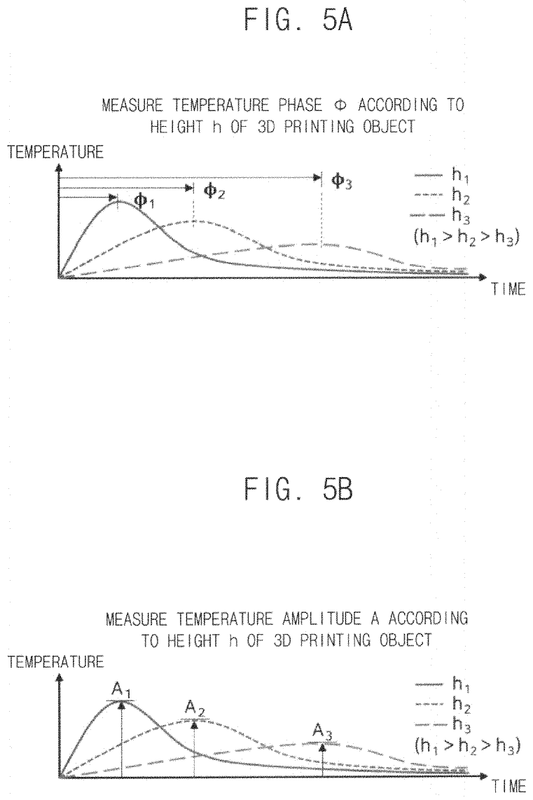

At this time, the temperature at position A after time Δt may be continuously measured by the thermal imaging camera 70. The temperature change over time at position A may be represented by a temperature phase graph and a temperature amplitude change graph of the 3D printing object, as shown in FIGS. 5A and 5B.

In an embodiment, the temperature phase graph and the temperature amplitude change graph may be used for estimating the height of the 3D printing object 4 to be measured. The temperature-related graph that can be used to estimate the height of the 3D printing object 4 may include at least one of the temperature phase graph or the temperature amplitude change graph. In estimating the height of the 3D printing object 4, using both of the temperature phase graph and the temperature amplitude change graph can more accurately estimate the height than using either graph.

FIG. 5A illustrates a graph of temperature phase according to the height of the 3D printing object, and FIG. 5B illustrates a graph of temperature amplitude according to the height of the 3D printing object.

As shown in FIGS. 5A and 5B, the temperature phase graph and the temperature amplitude change graph of the 3D printing object 4 may have different characteristics depending on the height of the 3D printing object 4. In an embodiment, to obtain the temperature phase graph and the temperature amplitude graph of the 3D printing object 4 that vary according to the height of the 3D printing object 4 as described above, it is necessary to repeatedly take thermal images of many 3D printing objects of various heights using the thermal imaging camera 70. The thermal images, temperature phase data, and temperature amplitude change data of the 3D printing objects obtained through this may be stored as big data having a correlation with the heights of the 3D printing objects.

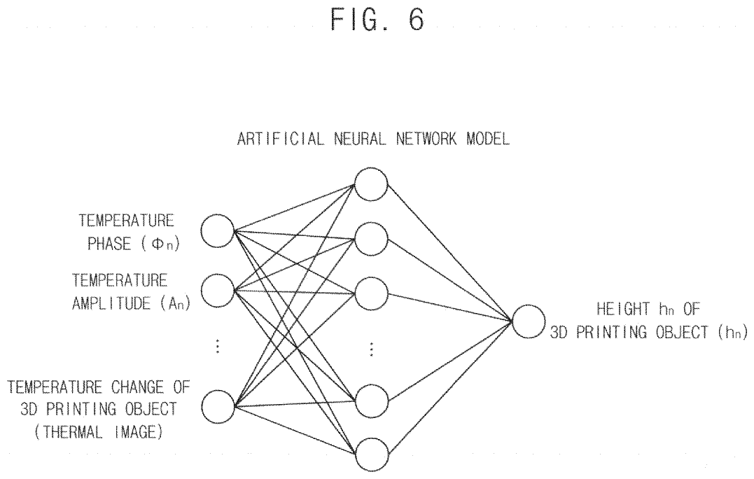

FIG. 6 shows a schematic diagram of analyzing a correlation between a thermal image and one or more temperature-related data and a height of the 3D printing object using machine learning.

Referring to FIG. 6, the calculation unit 80 may analyze the correlation between the heights of the 3D printing objects and the thermal images, temperature phase data, and temperature amplitude change data of the 3D printing objects, which were collected through lots of 3D printing processes. Based on the analysis, an artificial neural network model that can estimate a height of the 3D printing object 4 from a newly captured thermal image of the 3D printing object 4 may be built in the calculation unit 80 (S20).

In an example embodiment, machine learning may be used to analyze the correlation between the heights of the 3D printing objects and the thermal image, temperature phase data, and temperature amplitude change data of the 3D printing objects. The machine learning is the study of computer algorithms that improve automatically processing performance through empirical data. Machine learning algorithms build a model based on sample data, known as training data, by training them to make predictions or decisions without being explicitly programmed to do so. In the 3D printing system 1 according to an example embodiment, the calculation unit 80 may be configured to use a machine learning algorithm to input a thermal image and a temperature distribution data during 3D printing as input data, and to construct an artificial neural network model capable of estimating a height of the 3D printing object 4 corresponding to the input data by using the correlation between the heights of the 3D printing objects and the thermal images, temperature phase data, and temperature amplitude change data of the 3D printing objects.

In the above embodiment, it was illustrated to construct the artificial neural network model for estimating the height of the 3D printing object 4 from a thermal image using temperature phase data and temperature amplitude change data. However, the temperature-related data that can be used as an input variable for the artificial neural network model is not limited thereto. The process conditions of the 3D printing system, the intensity of the laser beam, the process speed, the size of the laser beam, the ejection amount of the base material powder, etc. may also be used as input variables for the construction of the artificial neural network model and for estimation of the height of the 3D printing object 4.

Any known machine learning algorithms or programs may be used for performing the machine learning to build the artificial neural network model.

Once the artificial neural network model has been constructed in the calculation unit 80 through the machine learning, a height of a new 3D printing object 4 can be estimated in real time by inputting a newly measured thermal image and one or more temperature-related data with respect to the new 3D printing object 4 into the artificial neural network model.

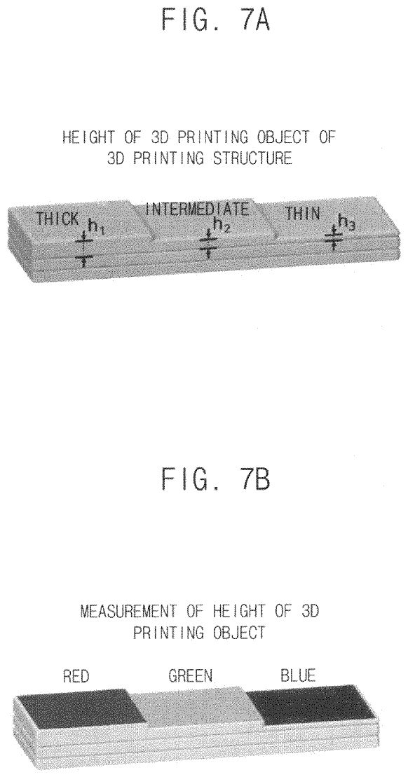

FIG. 7A illustrates 3D printing objects of a 3D printing structure, and FIG. 7B is a view showing the 3D printing objects of the 3D printing structure shown in FIG. 7A which are distinguished in different colors according to the heights thereof.

The height of the 3D printing object 4 estimated by the calculation unit 80 in real time may be displayed on a separate display unit 90 as shown in FIGS. 7A and 7B. That is, the 3D printing objects may be displayed as 3D or 2D type 3D printing objects having different colors respectively according to the values of heights. Accordingly, a user can accurately know in real time a height of the 3D printing object formed by the 3D printing process currently performed.

In this way, according to the example embodiments the height of the 3D printing object 4 can be known in real time. Thus, if an abnormality occurs in the height of the 3D printing object 4, it can be quickly detected and appropriate follow-up measures can be taken. If it is found that the height of the 3D printing object 4 is abnormal, the printing process may be controlled such that the height of the 3D printing object 4 comes to fall within a normal range by adjusting the related process conditions, such as the intensity of the laser beam, the process speed, the size of the laser beam, the discharge amount of the base powder, etc., or the printing process may be stopped to early prevent defective products from being produced.

The method according to the embodiments of the present disclosure can estimate the height of the 3D printing object in real time during the 3D printing process using a thermal imaging camera. Using this method, it is possible to check the height of the 3D printing object during the 3D printing process in real time. Therefore, it is possible to detect a defective printing product in which an abnormality occurs in the height of the 3D printing object at an early stage, thereby improving the quality of the product and increasing the process efficiency.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present disclosure. Accordingly, all such modifications are intended to be included within the scope of the present disclosure as defined in the claims.

What is claimed is:

1. A method of estimating a height of a 3D printing object formed during a 3D printing process, comprising:
extracting one or more temperature-related data of the 3D printing object formed during the 3D printing process;
building an artificial neural network model for estimating the height of the 3D printing object by using the extracted temperature-related data; and
estimating the height of the 3D printing object by inputting a newly measured thermal image and the one or more temperature-related data into the artificial neural network model,
wherein the one or more temperature-related data includes a surface temperature phase and a temperature amplitude change of the 3D printing object.

2. The method of claim 1, wherein the step of ‘extracting one or more temperature-related data of the 3D printing object’ comprises capturing a thermal image of the 3D printing object using the thermal imaging camera capable of measuring a temperature of the 3D printing object formed during the 3D printing process; and extracting one or more temperature-related data of the 3D printing object from the thermal image of the 3D printing object taken by the thermal imaging camera.

3. The method of claim 2, wherein the ‘building an artificial neural network model’ comprises collecting big data including thermal images, and information on correlations between one or more temperature-related data and the heights of the 3D printing object at various heights of the 3D printing object by repeatedly performing, at various heights of the 3D printing object, the steps of capturing a thermal image of the 3D printing object using the thermal imaging camera, and extracting one or more temperature-related data of the 3D printing object from the thermal image of the 3D printing object; and building the artificial neural network model by machine learning the collected big data.

4. The method of claim 1, wherein the 3D printing process is a 3D printing process using a direct energy deposition (DED) method.

5. The method of claim 1, wherein a base material of the 3D printing object is a metal material.

6. An apparatus for estimating a height of a 3D printing object formed during a 3D printing process, comprising:
a thermal imaging camera configured to measure a temperature of the 3D printing object formed during the 3D printing process; and
a calculation unit configured to estimate the height of the 3D printing object from the temperature of the 3D printing object unit measured by the thermal imaging camera,
wherein the calculation unit includes functions of: extracting one or more temperature-related data of the 3D printing object formed during the 3D printing process; building an artificial neural network model for estimating the height of the 3D printing object by using the extracted temperature-related data; and estimating the height of the 3D printing object by inputting a newly measured thermal image and the one or more temperature-related data values into the artificial neural network model, and
wherein the one or more temperature-related data includes a surface temperature phase and a temperature amplitude change of the 3D printing object.

7. The apparatus of claim 6, wherein the 3D printing process is a 3D printing process using a direct energy deposition (DED) method.

8. The apparatus of claim 6, wherein the function of ‘extracting one or more temperature-related data of the 3D printing object’ comprises a function of capturing a thermal image of the 3D printing object using the thermal imaging camera capable of measuring a temperature of the 3D printing object formed during the 3D printing process; and a function of extracting one or more temperature-related data of the 3D printing object from the thermal image of the 3D printing object taken by the thermal imaging camera.

9. The apparatus of claim 6, wherein the function of ‘building an artificial neural network model’ comprises a function of collecting big data including thermal images, and information on correlations between one or more temperature-related data and the heights of the 3D printing object at various heights of the 3D printing object by repeatedly performing, at various heights of the 3D printing object, tasks of capturing a thermal image of the 3D printing object using the thermal imaging camera and extracting one or more temperature-related data of the 3D printing object from the thermal image of the 3D printing object; and a function of building the artificial neural network model by machine learning the collected big data.

10. A system for 3D printing process, comprising:
a laser source configured to form a molten pool on a 3D printing object by irradiating a laser beam to melt a base material supplied to the 3D printing object;
a base material supply source configured to supply the base material to the 3D printing object;
a thermal imaging camera configured to measure a temperature of the 3D printing object by imaging the 3D printing object formed during the 3D printing process; and
a calculation unit configured to estimate the height of the 3D printing object from the temperature of the 3D printing object unit measured by the thermal imaging camera,
wherein the calculation unit includes functions of: extracting one or more temperature-related data of the 3D printing object formed during the 3D printing process; building an artificial neural network model for estimating the height of the 3D printing object by using the extracted temperature-related data; and estimating the height of the 3D printing object by inputting a newly measured thermal image and the one or more temperature-related data values into the artificial neural network model, and
wherein the one or more temperature-related data includes a surface temperature phase and a temperature amplitude change of the 3D printing object.

11. The 3D printing system of claim 10, wherein the thermal imaging camera is disposed such that at least a part of an optical path of the thermal imaging camera is coaxially with a laser beam irradiated from the laser source that melts a base material supplied to the 3D printing object.

12. The 3D printing system of claim 11, further comprising a beam splitter disposed on a beam path irradiated from the laser source; and an optical path converter disposed between the beam splitter and the thermal imaging camera to change a path of light, wherein the thermal imaging camera is disposed coaxially with the laser source.

13. The 3D printing system of claim 12, wherein the beam splitter is disposed between the laser source and a focus lens through which laser beam emitted from the laser source passes.

14. The 3D printing system of claim 13, wherein the calculation unit is configured to estimate the height of the 3D printing object in real time during the 3D printing process.

15. The 3D printing system of claim 10, wherein further comprising a display unit configured to display the height of the 3D printing object estimated by the calculation unit.

16. The 3D printing system of claim 10, wherein the function of ‘extracting one or more temperature-related data of the 3D printing object’ comprises a function of capturing a thermal image of the 3D printing object using the thermal imaging camera capable of measuring a temperature of the 3D printing object formed during the 3D printing process; and a function of extracting one or more temperature-related data of the 3D printing object from the thermal image of the 3D printing object taken by the thermal imaging camera.

17. The 3D printing system of claim 16, wherein the function of ‘building an artificial neural network model’ comprises a function of collecting big data including thermal images, and information on correlations between one or more temperature-related data and the heights of the 3D printing object at various heights of the 3D printing object by repeatedly performing, at various heights of the 3D printing object tasks, of capturing a thermal image of the 3D printing object using the thermal imaging camera and extracting one or more temperature-related data of the 3D printing object from the thermal image of the 3D printing object; and a function of building the artificial neural network model by machine learning the collected big data.
